(19) United States
(12) Patent Application Publication
(10) Pub. No.: US 2022/0182764 A1
(43) Pub. Date: Jun. 9, 2022

(54) Loudspeaker Diaphragms with Embedded Visual Elements and Methods of Manufacture

(71) Applicant: SYNG, Inc., Venice, CA (US)

(72) Inventors: Christopher John Stringer, Venice, CA (US); Ryan Mihelich, Venice, CA (US); Pere Aizcorbe Arrocha, Santa Monica, CA (US); Ananda Day, Venice, CA (US); Nathan Hoyt, Venice, CA (US); Afrooz Family, Los Angeles, CA (US); Matthias Kronlachner, Venice, CA (US)

(73) Assignee: SYNG, Inc., Venice, CA (US)

(21) Appl. No.: 17/457,639

(22) Filed: Dec. 3, 2021

Related U.S. Application Data
(60) Provisional application No. 63/121,144, filed on Dec. 3, 2020.
(60) Provisional application No. 63/121,205, filed on Dec. 3, 2020.

(51) Int. Cl. H04R 7/12; H04R 9/06

(52) U.S. Cl. CPC H04R 7/122; H04R 2307/029; H04R 9/06

(57) ABSTRACT

Systems and methods for fabricating loudspeaker diaphragms with embedded visual elements in accordance with embodiments of the invention are illustrated. One embodiment includes a loudspeaker diaphragm including a first transparent layer, a plurality of opaque layers, one or more inserts, where the one or more inserts are embedded in gaps in the plurality of opaque layers such that the one or more inserts are visible through the first transparent layer, and a second transparent layer, where the plurality of opaque layers is bonded between the first and second transparent layers.

### CROSS-REFERENCE TO RELATED APPLICATIONS

The current application claims the benefit of and priority under 35 U.S.C. § 119(e) to U.S. Provisional Patent Application No. 63/121,144 entitled “Loudspeaker Diaphragms with Embedded Visual Elements and Methods of Manufacture” filed Dec. 3, 2020, and U.S. Provisional Patent Application No. 63/121,205 entitled “Systems and Methods for Spatial Audio Rendering” filed Dec. 3, 2020, the disclosures of which are hereby incorporated by reference in their entireties for all purposes.

### FIELD OF THE INVENTION

The present invention generally relates to loudspeaker diaphragms with embedded visual elements, and methods for their manufacture.

### BACKGROUND

Loudspeakers (or “speakers”) are devices for reproducing sound. Speakers contain a driver that moves in response to an audio signal and pushes a diaphragm. The movement of the diaphragm in turn pushes air generating sound waves. Subwoofers (or “woofers”) are a type of speaker for generating low frequency sound. Generally, woofer diaphragms are larger than other types of loudspeakers such as tweeters for high frequency sound reproduction, and midranges (or “mids”) for mid frequency sound reproduction.

### SUMMARY OF THE INVENTION

Systems and methods for fabricating loudspeaker diaphragms with embedded visual elements in accordance with embodiments of the invention are illustrated. One embodiment includes a loudspeaker diaphragm including a first transparent layer, a plurality of opaque layers, one or more inserts, where the one or more inserts are embedded in gaps in the plurality of opaque layers such that the one or more inserts are visible through the first transparent layer, and a second transparent layer, where the plurality of opaque layers is bonded between the first and second transparent layers.

In another embodiment, the one or more inserts are transparent.

In a further embodiment, the one or more inserts are polycarbonate.

In still another embodiment, the loudspeaker diaphragm further includes a pigment deposited on the second transparent layer such that the pigment is visible through the first transparent layer and the one or more inserts.

In a still further embodiment, the second transparent layer faces a driver of the loudspeaker.

In yet another embodiment, the plurality of opaque layers includes sheets of carbon fiber weave.

In a yet further embodiment, the plurality of opaque layers includes three sheets of carbon fiber weave, and the three sheets of carbon fiber weave includes a first and third sheet of 3K carbon fiber weave, and a second sheet of 1K single direction carbon fiber weave, wherein the second sheet is bonded between the first and third sheet.

In another additional embodiment, the first transparent layer and the second transparent layer are fiberglass.

In a further additional embodiment, the loudspeaker diaphragm is a diaphragm for a woofer.

In another embodiment again, the loudspeaker diaphragm has sufficient rigidity to perform as a woofer diaphragm.

In a further embodiment again, a method for manufacturing a loudspeaker diaphragm with an embedded visual element, including bonding a plurality of opaque sheets to form a multi-ply sheet, the multi-ply sheet having a first side and a second side, punching a hole out of the multi-ply sheet to form a gap, bonding a first transparent sheet to the first side of the multi-ply sheet, forming an insert in a shape of the hole, inserting the insert into the multi-ply sheet into the gap, and bonding a second transparent sheet to the second side of the multi-ply sheet such that the insert is between the first and second transparent sheets to create a bonded assembly.

In still yet another embodiment, the method further includes depositing a pigment on the second transparent sheet, and wherein the insert is transparent.

In a still yet further embodiment, the method further includes cutting the bonded assembly to the shape of a woofer diaphragm.

In still another additional embodiment, the insert is formed from polycarbonate.

In a still further additional embodiment, the first transparent sheet and the second transparent sheet are fiberglass sheets.

In still another embodiment again, the plurality of opaque sheets includes carbon fiber weaves.

In a still further embodiment again, bonding a plurality of carbon fiber weaves to form a multi-ply sheet includes applying 6 Megapascals of pressure at between 150 and 170 degrees Celsius for 2 hours.

In yet another additional embodiment, the plurality of opaque layers includes three sheets of carbon fiber weave, and the three sheets of carbon fiber weave includes a first and third sheet of 3K carbon fiber weave, and a second sheet of 1K single direction carbon fiber weave, wherein the second sheet is bonded between the first and third sheet.

In a yet further additional embodiment, the method further includes applying 6 Megapascals of pressure at between 150 and 170 degrees Celsius for 2 hours to the bonded assembly.

In yet another embodiment again, the constructed loudspeaker diaphragm has sufficient rigidity to perform as a woofer diaphragm.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1A illustrates a speaker diaphragm with an embedded visual element in accordance with an embodiment of the invention.

FIG. 1B is an exploded view of a speaker diaphragm with an embedded visual element in accordance with an embodiment of the invention.

FIG. 2A illustrates a top view of a speaker diaphragm with a colored, embedded visual elements in accordance with an embodiment of the invention.

FIG. 2B illustrates a bottom view of a speaker diaphragm with a colored, embedded visual elements in accordance with an embodiment of the invention.

FIG. 3 is a flow chart of a first process for manufacturing speaker diaphragms with embedded visual elements in accordance with an embodiment of the invention.

FIG. 4 second process for manufacturing speaker diaphragms with embedded visual elements in accordance with an embodiment of the invention.

### DETAILED DESCRIPTION

Woofer diaphragms are not only a critical functional component of many loudspeakers, but also contribute greatly to the overall aesthetics of a loudspeaker. For example, many subwoofers allocate significant amounts of their front-facing, most visible surface to the diaphragm, thereby accounting for much of the look of the device. Many speakers are placed in living areas, retail locations, offices, and/or other areas where interior (or exterior) design is an important consideration. As such, it is desirable for both a diaphragm to have high quality functionality while maintaining a visually pleasing design. Further, speaker manufacturers may want to brand their products in a striking and/or pleasing way, and a diaphragm presents a desirable location for a visual element and/or other artwork, e.g. a brand.

Conventional methods for putting visual elements and/or artwork on diaphragms have included painting or printing visual elements directly on the surface of the diaphragm. However, these methods can present several problems. First, diaphragms are subjected to stress during operation of the loudspeaker, and many printed visual elements will wear off with long term use. Wearing can be further accelerated due to environmental conditions impacting the exterior surface of the diaphragm. Second, printing on top of the diaphragm will introduce an additional layer to the diaphragm which is visible and/or can be felt by consumers. This can give an impression of low quality. Even if an entire layer of print is introduced to the surface of the diaphragm to try and reduce the unevenness, additional cost and the previously mentioned wearing leaves much to be desired.

Diaphragms disclosed herein can have smooth surfaces and are not subject to the same wearing. However, having a smooth surface is not a necessity, and in many embodiments, textured surface layers can be used, and/or texture can be applied to the surface. Instead, they can include inserts within the diaphragm itself to display a visual element and/or other visual elements. As mentioned above, it is important to note that diaphragms are functional, and it is important to retain high quality. Rigidness and acoustic response are all important factors in diaphragm construction, and cutting holes in diaphragms can drastically impact their performance. Methods of construction described herein can account for these issues and enable construction of high-quality diaphragms that are aesthetically pleasing. Further, diaphragms herein can be constructed to be flat as opposed to the more traditional cone shape.

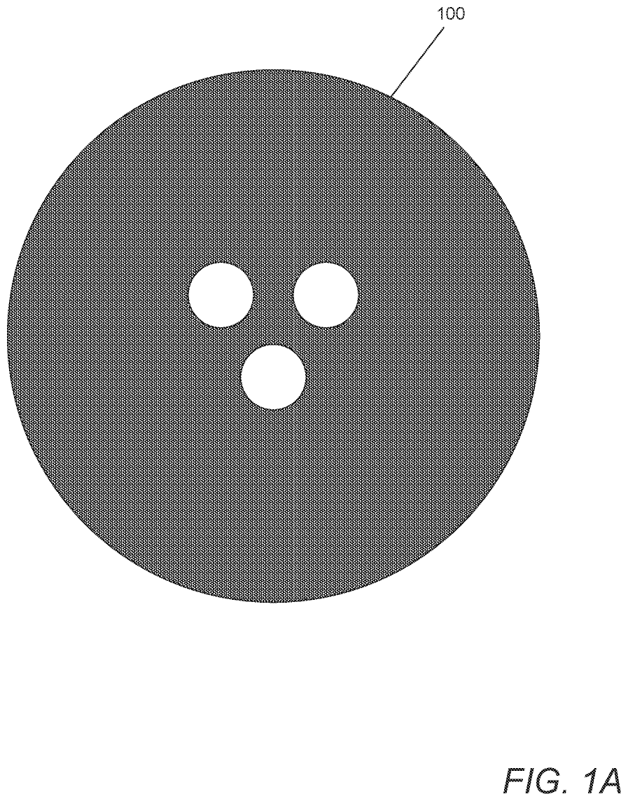

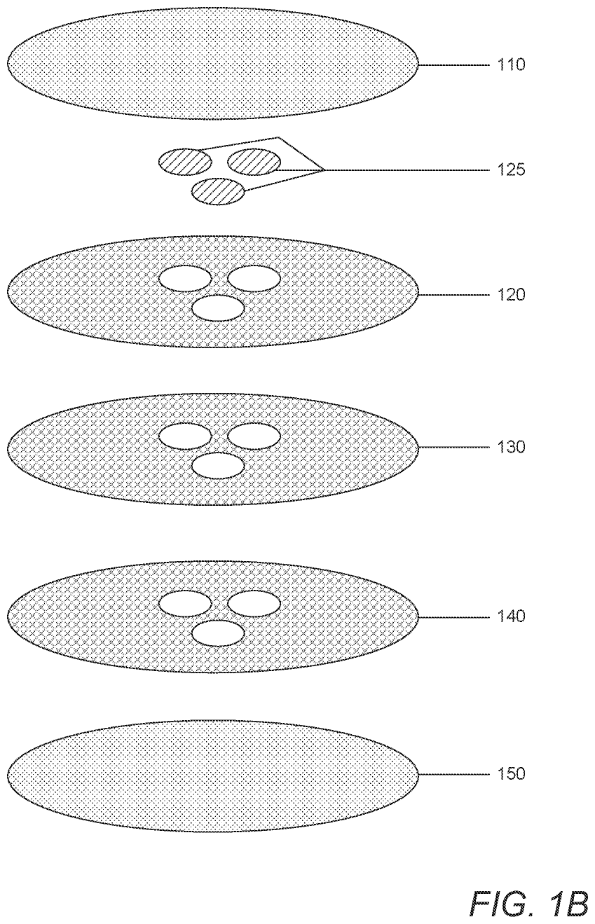

Turning now to FIG. 1A, a diaphragm with an embedded visual element in accordance with an embodiment of the invention is illustrated. The diaphragm 100 appears as a solid sheet with a visual element in the center. In the illustrated embodiment, the visual element is three dots located at the vertices of an equilateral triangle, however any arbitrary visual element can be inserted, and the three dots are merely an example. In numerous embodiments, the diaphragm visually appears as a carbon fiber weave with clear or colored filling as the visual element, although the look can be changed based on the materials chosen.

Turning now to FIG. 1B, an exploded view of the diaphragm in accordance with an embodiment of the invention is illustrated. In many embodiments, the diaphragm is composed of five or more layers. The first layer 110 is a clear layer. In numerous embodiments, the first layer is made of transparent fiberglass. The second layer 120, the third layer 130, and the fourth layer 140 can be constructed from carbon fiber weave sheets. In many embodiments, the weaves are not all the same pattern. For example, in various embodiments, the second and fourth layers are 3K (3000 filaments per tow) straight weave carbon fiber sheet, and the third layer is a 1K (1000 filaments per tow) single direction carbon fiber sheet. However, the specific weaves of carbon fiber can be varied depending on the amount of rigidity required for the application, and/or the desired exterior look of the product. Further, in many embodiments, different materials such as, but not limited to, Kevlar, fiberglass, ceramic, metal, paper, any/or any other material with appropriate rigidity can be used as appropriate to the requirements of specific applications of embodiments of the invention.

In the illustrated embodiment, the second layer, the third layer, and the fourth layer are all punched to have one or more gaps in the shape of the visual element to be embedded. In the embodiment illustrated in FIG. 1B, the gaps are three circular holes, but depending on the desired visual element, there may be one gap, many gaps, gaps of varying sizes and shapes, etc. The gaps are filled by inserts 125. In numerous embodiments, the inserts fit the gaps with a high degree of precision. In a variety of embodiments, the inserts are made of transparent polycarbonate. However, other materials can be used such as, but not limited to, colored plastics, metals, acrylic, acrylonitrile butadiene styrene (ABS), and/or any other material as appropriate to the requirements of specific applications in accordance with various embodiments of the invention.

In the illustrated embodiment, the fifth layer 150 is another clear layer. In many embodiments, the clear layer is again made of fiberglass, although the material can vary. When all five layers are combined, a single diaphragm is created where the second layer is visible through the first layer, and the fourth layer is visible through the fifth layer. Further, the inserts can be seen from either side of the diaphragm. In many embodiments, the combination can involve any number of processes including (but not limited to) a bonding process, a lamination process, pressure application, a curing process, and/or any other combination methodology as appropriate to the requirements of specific applications of embodiments of the invention. Details of various processes that can be utilized to combine layers are discussed further below.

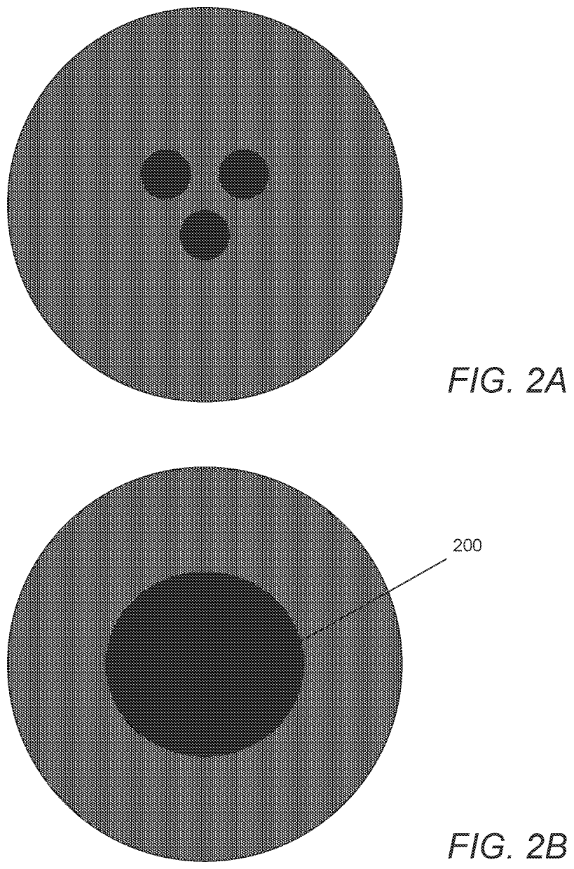

If the inserts are made of a clear material, it will appear to a viewer as if there is a hole in the diaphragm. Clear layers 110 and 150 and inserts 125 are illustrated with shading to differentiate from the gaps, and said shading is not meant to require any particular patterning. Indeed, as noted, in many embodiments said layers and/or inserts are transparent (or translucent). Similarly, in many embodiments, when clear inserts are used, a layer of pigment can be deposited on one side of the diaphragm and it will appear to a viewer observing the other side of the diaphragm as if the inserts are colored the shade of the pigment. In numerous embodiments, this results in a diaphragm that looks and feels smooth on one side while displaying a visual element which looks seamlessly as part of the surface of the diaphragm. An example of a diaphragm with a colored embedded visual element in accordance with an embodiment of the invention as viewed from the front and back are illustrated in FIGS. 2A and 2B, respectively. As can be seen, a printed layer of pigment 200 on the bottom surface yields a visual element which appears to be the color of said printed layer. The printed layer can easily be hidden by having the bottom surface face towards in the interior of the woofer. In some embodiments, colored plastic inserts can be used instead of clear plastic inserts, although this can be more expensive depending on the type of plastic used.

As can be readily appreciated, while FIGS. 1A and 1B illustrate a diaphragm with 5 layers, a diaphragm with 3 layers, or any odd number of layers can be made by adding additional sheets of material in the center with gaps as appropriate to the requirements of specific applications of embodiments of the invention. Further, materials other than polycarbonate, carbon fiber, and fiberglass can be used such as, but not limited to, paper and other fabrics depending on the required properties of the diaphragm for a particular use case. In many embodiments, the materials by themselves and/or as a stack have sufficient rigidity to produce audio when driven at bass frequencies. In various embodiments, the interior layers (e.g. not the exterior transparent layers) are made of any translucent or opaque material as appropriate to the requirements of specific applications in accordance with various embodiments of the invention. Further, additional sheets or fewer sheets of material can be introduced respectively as appropriate to the requirements of specific applications of embodiments of the invention Methods for manufacturing diaphragms with embedded visual elements in accordance with a number of embodiments of the invention are discussed further below.

### Methods of Diaphragm Construction

Diaphragms with embedded visual elements can remain highly functional while creating a pleasing visual aesthetic. In many embodiments, diaphragms are created by fusing numerous sheets of material together. The particular materials used can impact the binding methodology and timings. As can be readily appreciated, materials and parameters can be varied without departing from the scope or spirit of the invention.

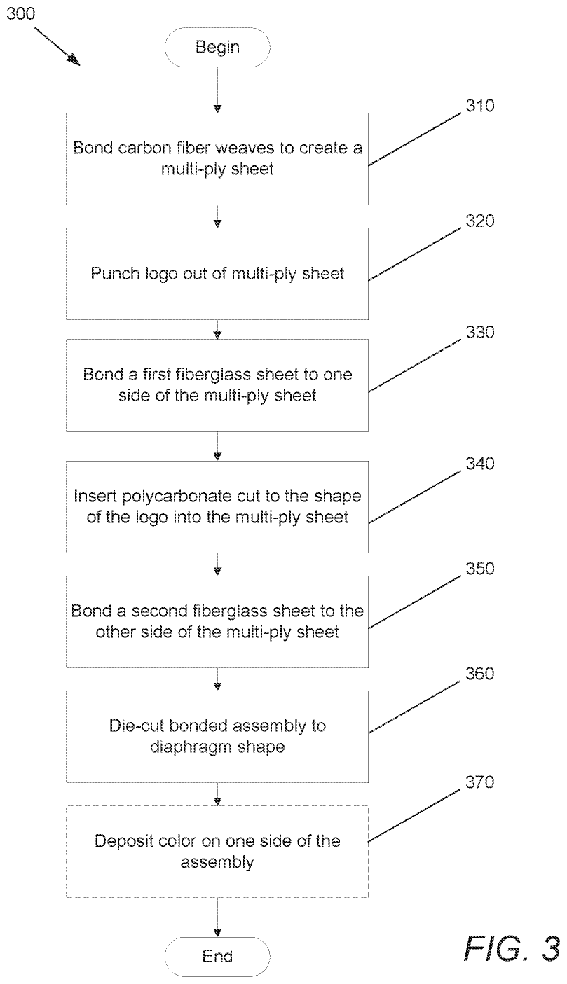

Turning now to FIG. 3, a process for manufacturing diaphragms with embedded visual elements in accordance with an embodiment of the invention is illustrated. Process 300 includes bonding (310) a number of carbon fiber weave sheets to create a multi-ply carbon fiber sheet. In a variety of embodiments, three carbon fiber weave sheets are bonded, although more can be used. In many embodiments, the carbon fiber weave sheets include different weave types. In various embodiments, the weave types are symmetrically balanced across layers, although it is not a requirement. In numerous embodiments, the carbon fiber weave sheets are bonded using an epoxy resin. In many embodiments, the carbon fiber weave sheets are bonded using a pre-preg and curing process. It is important to note that in some cases, this step is skipped when one carbon fiber sheet is used, in which case the following process can be performed using a single carbon fiber sheet rather than a multi-ply carbon fiber sheet.

The multi-ply sheet is punched (320) to create one or more gaps in the multi- ply sheet in the shape of the visual element. In various embodiments, the multi-ply carbon fiber sheet is die cut to create the gaps, although any cutting methodology can be used as appropriate to the requirements of specific applications of embodiments of the invention. A first fiberglass sheet can then be bonded to one side of the multi-ply carbon fiber sheet. In many embodiments, the bonding is achieved using epoxy and/or any other chemical bonding methodology (e.g. pre-preg).

Polycarbonate inserts in the shape of the visual element(s)can be inserted (340) into the gap(s) in the multi-ply carbon fiber sheet, and a second fiberglass sheet can be bonded (350) to the other side of the multi-ply carbon fiber sheet such that the multi-ply carbon fiber sheet is sandwiched between the first and second fiberglass sheets. This bonding process again can be achieved using epoxy and/or any other chemical bonding methodology (e.g. pre-preg). The fiberglass-multi-ply carbon fiber sheet-fiberglass assembly is then die-cut (360) into the desired shape of the diaphragm. In various embodiments, other cutting methods can be used as appropriate to the requirements of specific applications of embodiments of the invention. In various embodiments, the assembly can be further molded into a non-planar shape. As can be readily appreciated, many different materials can be utilized as appropriate to the requirements of specific applications of embodiments of the invention. For example, depending on the frequency and/or power of the driver, different materials can be used to adjust the rigidity of the diaphragm. Further, although three layers of carbon fiber are described between two fiberglass sheets, more or fewer layers can be used.

In many embodiments, a layer of pigment is deposited (370) onto one side of the assembly either before or after cutting to yield a colored visual element effect for the resulting inserted visual element. In numerous embodiments, a sheet of pigment is bonded to one side, although any pigment application method can be used as appropriate to the requirements of specific applications of embodiments of the invention. As can be readily appreciated, the bonding methodologies used can vary based on the specific materials used. For example, various hot and cold pressing stages can be used depending on the bonding method and materials as appropriate to the requirements of specific applications of embodiments of the invention.

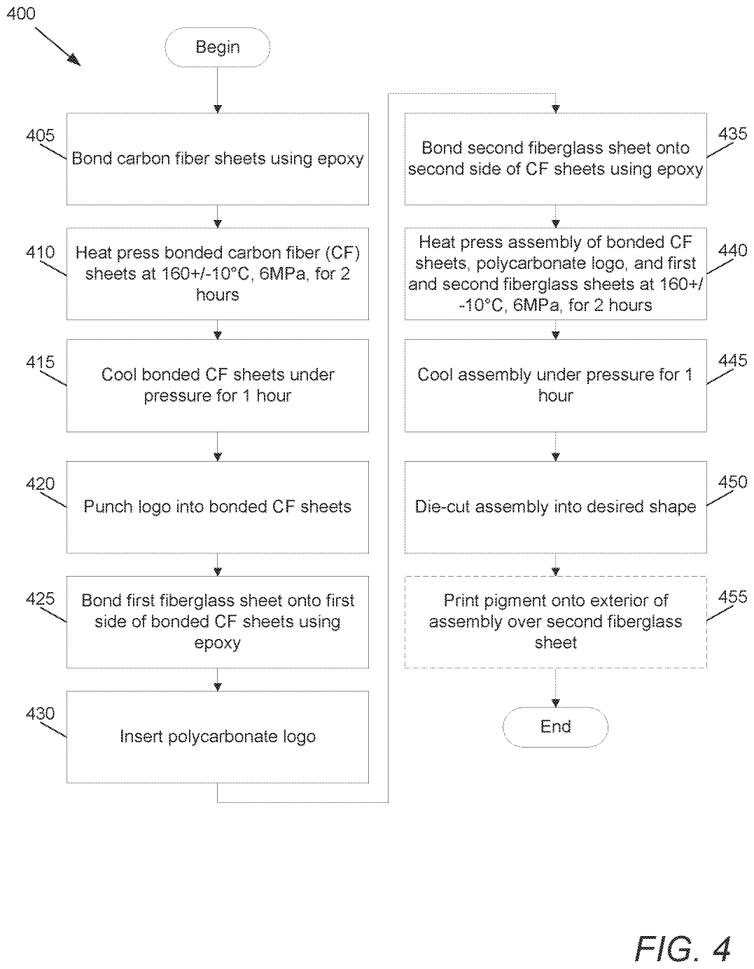

By way of specific example, FIG. 4 is a flow chart for a method of construction using an epoxy resin in accordance with an embodiment of the invention. Process 400 includes bonding (405) carbon fiber sheets using an epoxy resin. The carbon fiber sheets are pressed (410) together at 160+/−10° C. at 6 MPa of pressure for approximately 2 hours. They are then allowed to cool (415) under pressure for 1 hour. Gap(s) is/are punched out (420) in the shape of the desired visual element to be embedded and a first fiberglass sheet is bonded (425) onto one side of the bonded carbon fiber sheets using an epoxy resin. One or more polycarbonate inserts in the shape of the visual element(s) are inserted (430) into the gap(s). A second fiberglass sheet is bonded (435) onto the second side of the bonded carbon fiber sheet, trapping the polycarbonate inserts between the two fiberglass sheets and the carbon fiber sheets. The assembly of carbon fiber sheets, fiberglass sheets, and the polycarbonate inserts are pressed (440) together at 160+/−10° C. at 6 MPa of pressure for approximately 2 hours. They are then allowed to cool (445) under pressure for 1 hour. The assembly is then die-cut (450) to the desired shape. In many embodiments, pigment is printed (455) onto the exterior of the assembly over the second fiberglass sheet to create the appearance of a colored visual element when viewed from the first fiberglass sheet. While FIG. 4 recites a specific process with specific temperatures, times, and pressures, as can be readily appreciated, said method can be modified depending on the specific chemical requirements of the bonding agent. For example, some epoxy resins may have different curing processes which require different temperatures, pressures, or timings, which can be used without departing from the scope or spirit of the invention.

In many embodiments, diaphragms as described herein can be utilized in the construction of cells as described in U.S. patent application Ser. No. 16/839,021 titled “Systems and Methods for Spatial Audio Rendering” filed Apr. 2, 2020, the disclosure of which is incorporated by reference in its entirety. In numerous embodiments, cells include woofers that utilize at least one woofer that includes a diaphragm with one or more embedded visual elements. In various embodiments, cells include halos that may also have fins inside each horn which can provide increased structural support and/or enhance audio directivity.

Although various woofers with embedded visual elements and methods for their manufacture are discussed above, many constructions can be implemented in accordance with many different embodiments of the invention. For example, when more or less rigidity is required, additional sheets or fewer sheets of material can be introduced respectively as appropriate to the requirements of specific applications of embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A loudspeaker diaphragm comprising:
a first transparent layer;
a plurality of opaque layers;
one or more inserts, where the one or more inserts are embedded in gaps in the plurality of opaque layers such that the one or more inserts are visible through the first transparent layer; and
a second transparent layer;
where the plurality of opaque layers is bonded between the first and second transparent layers.

2. The loudspeaker diaphragm of claim 1, where the one or more inserts are transparent.

3. The loudspeaker diaphragm of claim 2, wherein the one or more inserts are polycarbonate.

4. The loudspeaker diaphragm of claim 2, further comprising a pigment deposited on the second transparent layer such that the pigment is visible through the first transparent layer and the one or more inserts.

5. The loudspeaker diaphragm of claim 4, wherein the second transparent layer faces a driver of the loudspeaker.

6. The loudspeaker diaphragm of claim 5, wherein the plurality of opaque layers comprises sheets of carbon fiber weave.

7. The loudspeaker diaphragm of claim 6, wherein the plurality of opaque layers comprises three sheets of carbon fiber weave, and the three sheets of carbon fiber weave comprises:
a first and third sheet of 3K carbon fiber weave; and
a second sheet of 1K single direction carbon fiber weave;
wherein the second sheet is bonded between the first and third sheet.

8. The loudspeaker diaphragm of claim 1, wherein the first transparent layer and the second transparent layer are fiberglass.

9. The loudspeaker diaphragm of claim 1, wherein the loudspeaker diaphragm is a diaphragm for a woofer.

10. The loudspeaker diaphragm of claim 9, wherein the loudspeaker diaphragm has sufficient rigidity to perform as a woofer diaphragm.

11. A method for manufacturing a loudspeaker diaphragm with an embedded visual element, comprising:
bonding a plurality of opaque sheets to form a multi-ply sheet, the multi-ply sheet having a first side and a second side;
punching a hole out of the multi-ply sheet to form a gap;
bonding a first transparent sheet to the first side of the multi-ply sheet;
forming an insert in a shape of the hole;
inserting the insert into the multi-ply sheet into the gap; and
bonding a second transparent sheet to the second side of the multi-ply sheet such that the insert is between the first and second transparent sheets to create a bonded assembly.

12. The method for manufacturing a loudspeaker diaphragm with an embedded visual element of claim 11, further comprising depositing a pigment on the second transparent sheet, and wherein the insert is transparent.

13. The method for manufacturing a loudspeaker diaphragm with an embedded visual element of claim 11, further comprising cutting the bonded assembly to the shape of a woofer diaphragm.

14. The method for manufacturing a loudspeaker diaphragm of claim 11, wherein the insert is formed from polycarbonate.

15. The method for manufacturing a loudspeaker diaphragm of claim 11, wherein the first transparent sheet and the second transparent sheet are fiberglass sheets.

16. The method for manufacturing a loudspeaker diaphragm of claim 11, wherein the plurality of opaque sheets comprises carbon fiber weaves.

17. The method for manufacturing a loudspeaker diaphragm of claim 16, wherein bonding a plurality of carbon fiber weaves to form a multi-ply sheet comprises applying 6 Megapascals of pressure at between 150 and 170 degrees Celsius for 2 hours. The method for manufacturing a loudspeaker diaphragm of claim 16, wherein the plurality of opaque layers comprises three sheets of carbon fiber weave, and the three sheets of carbon fiber weave comprise:
a first and third sheet of 3K carbon fiber weave; and
a second sheet of 1K single direction carbon fiber weave;
wherein the second sheet is bonded between the first and third sheet.

19. The method for manufacturing a loudspeaker diaphragm of claim 11, further comprising applying 6 Megapascals of pressure at between 150 and 170 degrees Celsius for 2 hours to the bonded assembly.

20. The method for manufacturing a loudspeaker diaphragm of claim 11, wherein the constructed loudspeaker diaphragm has sufficient rigidity to perform as a woofer diaphragm.
